(19) United States
(12) Patent Application Publication
(10) Pub. No.: US 2025/0360870 A1
(43) Pub. Date: Nov. 27, 2025

(54) GLAZED ASSEMBLY FOR A MOTOR VEHICLE AND ASSOCIATED MANUFACTURING METHOD

(71) Applicant: SAINT-GOBAIN GLASS FRANCE, COURBEVOIE (FR)

(72) Inventors: Keihann YAVARI, COURBEVOIE (FR); Christophe KLEO, COURBEVOIE (FR); Laurent SILVESTRINI, COURBEVOIE (FR); Mickael BONHOMME, COURBEVOIE (FR); Diane LEBLANC, COURBEVOIE (FR); Xavier DROUET, THOUROTTE (FR); Claire DAVIS, COURBEVOIE (FR); Buyin YU, COURBEVOIE (FR)

(21) Appl. No.: 18/874,944

(22) PCT Filed: Jun. 14, 2023
(86) PCT No.: PCT/EP2023/066015

§ 371 Date: Dec. 13, 2024

(30) Foreign Application Priority Data
Jun. 15, 2022 (FR) 2205822

(51) Int. Cl. B60Q 3/208; B32B 3/26; B32B 17/10

(52) U.S. Cl. CPC B60Q 3/208; B32B 3/266; B32B 17/10036; B32B 17/10651; B32B 2307/41; B32B 2307/416; B32B 2307/51; B32B 2605/00

(57) ABSTRACT

A glazed assembly includes a glazing unit for a motor vehicle, the glazing unit including a glass sheet that has first and second main faces, a light injection system for injecting light into the glass sheet, at least a portion of the generated light being injected into the glass sheet in order to propagate by reflection between the first and second main faces until reaching light extraction system. The glazed assembly further includes an opaque material that is in continuous direct contact with the first main face and is positioned between the light injection system and the light extraction system.

### PRIOR ART

The present invention belongs to the general field of manufacturing illuminated glazings. It relates more particularly to a glazed assembly comprising a glazing for a motor vehicle and configured to illuminate said glazing. It also concerns a manufacturing method for such a glazed assembly. The invention finds a particularly advantageous, although by no means limiting, application in the case where the automotive glazing to be illuminated is a glazed roof.

The use of a light source to illuminate (light up) a motor vehicle glazing is now widespread. As is well known, this can apply to any type of glazing on such a vehicle, whether single-glazed or laminated, that is, the windshield, rear window, side window or glazed roof.

When illuminated, this type of glazing is essentially used for ambient lighting or light signage. Typically, the light source used to implement such a lighting or signage function comprises one or more lighting modules, each comprising one or more light-emitting diodes (LEDs).

The general principle underlying the creation of an illuminated glazing is to position the light source in such a way that at least part of the light generated by it is injected into a sheet of glass in the glazing. More specifically, light is injected so as to propagate by reflection between two faces of the glass sheet, a first main face (for example, facing the vehicle interior) and a second opposite main face, until it reaches light extraction means (also known as “diffusing means/elements”).

In other words, the light source is optically coupled to the glass sheet in question, the latter then forming a light guide (that is, light propagation takes place by total internal reflection between said first and second main faces), and emerges from this guide at predetermined points by means of light extraction means.

In practice, various alternatives are conventionally used to implement this light injection principle.

Thus, according to a first example, one or more LED modules are incorporated at the edge of a glass sheet of a glazing, so that the light emitted by the LEDs enters through the edge of said glass sheet, and is guided by it to the light extraction means.

According to a second example, one or more LED modules are arranged opposite the first main face, with at least part of the light thus generated being incident on said first main face so as to pass through the glass sheet to leave it at the second main face. In addition, a light redirecting element is arranged at the second main face to reflect into the glass sheet light coming into contact with said redirecting element.

While these alternatives often produce satisfactory results in terms of the desired lighting function (ambience or signage), they are nonetheless problematic in that they generate undesirable optical effects.

In fact, some of the light generated by the light source may not be injected into the glass sheet, so that it emerges in the immediate vicinity of the glass surface. This light, which is not injected into the glass sheet and is referred to as “grazing light”, is therefore directly visible from an observation direction substantially parallel to the glazing, creating not only light “pollution”, but also the problem of illuminating any asperities on the glass surface (such as dust).

This problem of grazing light can be alleviated by positioning, in the vicinity of the light source, an element configured to block light that is not injected into the glass sheet. More specifically, this blocking element is placed in contact with the glazed surface, at one of the main faces, so as to hide the light source along a viewing direction substantially parallel to the glazing. This solution is nonetheless deficient in that said blocking element is attached to the glazing by translucent adhesive means. As a result, the light injected into the glass sheet that comes into contact with the face where the blocking element is positioned is extracted by the latter. The result is an optical effect known as a “halo”, localized at the contact point between the blocking element and the glazing, and also a source of light pollution.

### OVERVIEW OF THE INVENTION

The aim of the present invention is to remedy some or all of the disadvantages of the prior art, in particular those set out above, by proposing a solution which makes it possible to inject light into a sheet of glass in an automobile glazing while avoiding undesirable optical effects such as grazing light or halo.

Thus, and according to a first aspect, the invention relates to a glazed assembly comprising:
a glazing for a motor vehicle comprising a sheet of organic or inorganic glass having a first main face and a second opposite main face,
means for injecting light into the glass sheet, said injection means comprising a light source, at least part of the light generated by the light source being injected into the glass sheet to propagate by reflection between said first and second main faces to reach light extraction means.
   Said glazed assembly further comprises an opaque material in continuous and direct contact with the first main face and positioned between the light injection means and the light extraction means.

“Continuous contact” here refers to uniform contact between the glazing and the opaque material, with no disparities (that is, no gaps). The advantage of this continuous contact is that it prevents any leakage of stray light (grazing light) from the light source.

Furthermore, by “direct contact” we mean that the contact in question between the glazing and the opaque material is achieved without adhesive means, in particular without translucent adhesive means. Such arrangements are particularly advantageous in that they prevent any local absorption of light at the point of contact between the glazing and the opaque material, and therefore a fortiori prevent the appearance of a halo effect.

In particular embodiments, the glazed assembly may further comprise several of the following features, taken alone or in any technically feasible combinations.

In particular embodiments, the glazed assembly further comprises means for retaining the opaque material against the first main face by compression.

In particular embodiments, the retaining means comprise:
a support element, for example a plate, comprising a first face to which the light source is attached, and a second opposite face, the opaque material being attached to the first face of the support element,
a retaining element comprising first and second “retaining” arms connected together by a “connecting” arm, the first retaining arm being attached in abutment against the first main face of the glass sheet on the side opposite the opaque material with respect to the light source, the second retaining arm being attached in abutment against the second face of the support element.

In particular embodiments, the retaining means comprise a retaining element having first and second “retaining” arms interconnected by a “connecting” arm, the first retaining arm being attached in abutment against the first main face of the glass sheet on the side opposite the opaque material with respect to the light source, the light source and the opaque material being attached to the second retaining arm.

In particular embodiments, the light source is arranged opposite the first main face, in contact with or at a distance from the first main face, at least part of the light generated by the light source being incident on the first main face so as to pass through the glass sheet to leave it at the second main face, the light injection means further comprising a light redirection element arranged at the second main face and configured so that light leaving the second main face and coming into contact with said redirection element is reflected in the glass sheet.

In particular embodiments, the light redirection element is a reflective structure provided with a plurality of reflective surfaces in the form of inclined surfaces, the reflective surfaces being configured so that light leaving the second main face and coming into contact with them is reflected into the glass sheet.

In particular embodiments, the light source is arranged at least partially in a through hole in the glass sheet, said light source being:
in contact with a wall of the hole positioned between the light source and the light extraction means, or
at a distance from the walls of the hole.

In particular embodiments, the glazing is a monolithic glazing, said first main face being the face F1.

In particular embodiments, the glazing is a laminated glazing comprising two sheets of glass, an outer sheet and an inner sheet, separated by an interlayer film, said first main face being face F4.

In particular embodiments, the through-hole is made in the inner sheet.

In particular embodiments, the glazing comprises a functional layer, such as an infrared radiation-reflective layer.

In particular embodiments, the outer sheet is dyed and/or the interlayer film is dyed, at least in sections.

In particular embodiments, the light source comprises one or more lighting modules, each lighting module comprising one or more light-emitting diodes.

In particular embodiments:
light injection is achieved by direct optical coupling between the light source and the glazing, or
light injection is achieved by means of an optical system configured to perform an optical function from the light generated by the light source, for example a collimating optical system.

In particular embodiments, the opaque material is an elastic material, such as an elastomer, thermoplastic elastomer or foam.

In particular embodiments, the opaque material is not arranged opposite the light extraction means in a direction substantially perpendicular to the glazing.

In particular embodiments, a light extraction zone is defined comprising all the light extraction means and a projection of the light extraction zone in a projection plane perpendicular to the glazing, a projection of the opaque element in said projection plane being outside the projection of the light extraction zone.

According to a second aspect, the invention concerns a method for manufacturing a glazed assembly. Said method comprises steps consisting of:
providing a glazing for a motor vehicle comprising an organic or mineral glass sheet having a first main face and a second opposite main face,
having means for injecting light into the glass sheet, said injection means comprising a light source, at least part of the light generated by the light source being injected into the glass sheet to propagate by reflection between said first and second main faces until it reaches light extraction means,
positioning, between the light injection means and the light extraction means, an opaque material in continuous and direct contact with the first main face.

In particular modes of implementation, the method further comprises a step consisting in arranging means for retaining the opaque material against the first main face by compression.

According to a third aspect, the invention relates to the use of a glass assembly according to the invention in a motor vehicle, for example as a windshield, rear window, side window or glazed roof.

According to a fourth aspect, the invention relates to a motor vehicle comprising a glazed assembly according to the invention.

### BRIEF DESCRIPTION OF THE DRAWINGS

Other features and advantages of the present invention will emerge from the non-limiting description given below, with reference to the appended drawings that illustrate an exemplary embodiment thereof. In the figures:

FIG. 1 schematically depicts a particular embodiment of a glazed assembly according to the invention;

FIG. 2 schematically represents another particular embodiment of a glazed assembly according to the invention;

FIG. 3 is a schematic view of three quarters of the holding means of the glazed assembly of [FIG. 2], to which an opaque material is attached;

FIG. 4 schematically depicts another particular embodiment of a glazed assembly according to the invention;

FIG. 5 schematically depicts another particular embodiment of a glazed assembly according to the invention;

FIG. 6 depicts, in flowchart form, the main steps of a method for manufacturing a glazed assembly according to the invention.

### DESCRIPTION OF EMBODIMENTS

The present invention relates to the illumination (lighting up) of one or more glazings of a motor vehicle.

The rest of the description is aimed more particularly at a car-type motor vehicle, for example an electric and/or autonomous car. “Electric car” refers here to a car that comprises at least one electric motor and which, in order to move (that is, to operate said at least one electric motor), uses only the on- board electrical energy from one or several batteries that equip it.

It is important, however, to note that the present invention is not limited to the case of an electric and/or self-driving car and may equally relate to a hybrid car or else a car equipped only with a combustion engine, self-driving or otherwise.

Even more generally, the fact of considering a car-type motor vehicle does not constitute a limitation of the invention, as the latter remains applicable to any type of motor vehicle, such as a truck, a bus, etc.

For the rest of the description, we also consider that the illumination concerns a single glazing in the car, in this case the car roof (consequently, the roof in question is glazed).

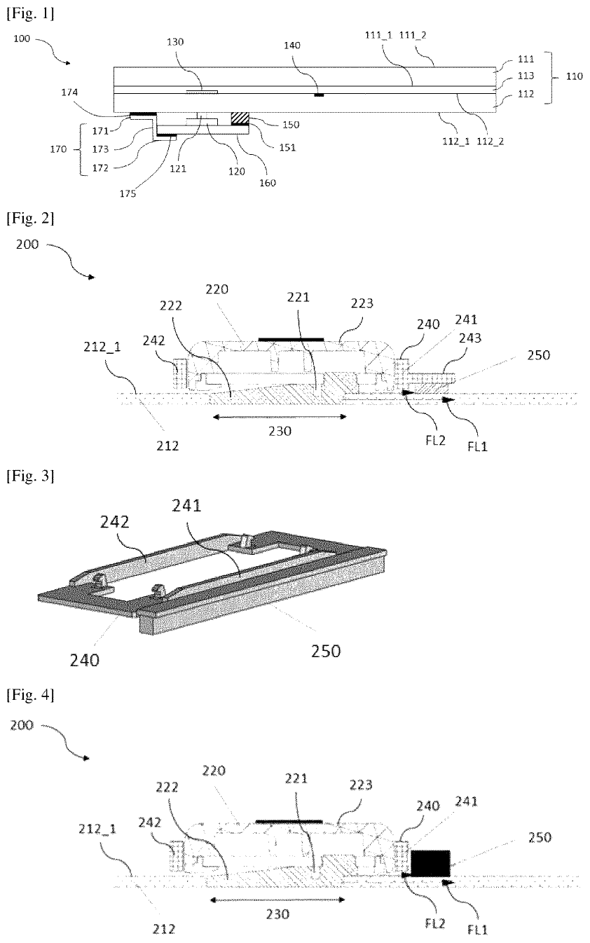

However, such arrangements are only one variant of implementation of the invention, as the number and type of glazings that can be illuminated is not a limiting factor. For example, there is no reason why all or part of the glazings should not be illuminated, whether the windshield, the rear window, a side window or the glazed roof.

[FIG. 1] schematically depicts a particular embodiment of a glazed assembly 100 according to the invention.

The glazed assembly 100 comprises the glazed roof 110, with [FIG. 1] corresponding to a cross-sectional view of said glazed roof 110. In the present embodiment, the glazed roof 110 is a laminated glazing comprising two sheets of glass, an outer sheet 111 and an inner sheet 112, separated by an interlayer film 113.

The inner glass sheet 112 (respectively the outer glass sheet 111) is intended to be arranged on the inside of the car, that is, in contact with the car's interior (respectively to be arranged on the outside of the car, that is, in direct contact with the atmosphere outside the car).

Each sheet of glass 111, 112 comprises a first main face 111_1 intended to face the interior of the car, and an opposite second main face 111_2, 112_2, said first and second main faces being connected to one another by a peripheral edge. Conventionally, the first and second main faces 111_1, 111_2 of the outer sheet 111 (respectively the first and second main faces 112_1, 112_2 of the inner sheet 112) are also referred to respectively as face F2 and face F1 (respectively face F4 and face F3).

There is no limitation on the type of glass used to form the glass sheets 111, 112. It can be either organic or mineral glass. Glass sheets 111, 112 can also be untempered, partially tempered or tempered glass.

By way of example, the outer 111 and/or inner 112 glass sheet is made of soda-lime glass, quartz glass, borosilicate glass or alumino-silicate glass. In other examples, the outer 111 and/or inner 112 glass sheet is made from rigid, transparent plastics, such as polycarbonate, polyethylene terephthalate (PET) or polymethyl methacrylate.

For the inner sheet 112, a colorless soda-lime mineral glass such as the glass Planilux® marketed by the applicant will preferably be used. The inner sheet 112 typically has a thickness of between 1.4 and 3.2 mm, preferably between 1.4 and 2.1 mm (this thickness can vary between 2.5 and 6 mm in the case of single glazing, that is, monolithic and non-laminated).

The outer sheet 111 can of course be as transparent and colorless as the inner sheet 112. In some exemplary embodiments, a laminated glazing according to the invention will consist of two colorless Planilux® sheets.

Unlike the inner sheet 112, the outer sheet 111 is advantageously made of tinted glass, for example Venus®, TSA3+ or TSA4+ glass, also marketed by the Applicant. The outer sheet 111 typically has a thickness in the range between 1.4 and 2.1 mm.

In more specific exemplary embodiments (not shown in the figures), said laminated glazing may comprise a functional layer. There is no limitation on the nature of the functional layer. For example, it could be a layer that reflects infrared radiation. Generally speaking, the person skilled in the art knows which functional layers can be envisaged for a laminated glazing of a motor vehicle, and also knows where to position (that is, on which face of the glazing) such a functional layer. Consequently, these aspects are not described further here.

The interlayer film 113, meanwhile, is in adhesive contact with the two glass sheets 111, 112, and more specifically with the first main face 111_1 of the outer sheet 111 and the second main face 112_2 of the inner sheet 111. It can be made of any transparent polymer material commonly used for this purpose, such as polyvinyl butyral (PVB), thermoplastic polyurethane (TPU) or ethylene vinyl acetate copolymer (EVA). The interlayer typically has a thickness in the range between 0.2 and 1.1 mm and may be colorless or tinted in sections or fully tinted.

The glazed assembly 100 also comprises means for injecting light into the glazed roof. More particularly, in the embodiment described here with reference to [FIG. 1], said injection means are configured to inject light into the inner glass sheet 112 and comprise a light source, at least part of the light generated by the light source being injected into the inner glass sheet 112 to propagate by reflection between said first and second main faces 112_1, 112_2.

The light source may, for example, comprise one or more lighting modules, each lighting module comprising one or more light-emitting diodes (LEDs). LEDs can be front or side emitting.

Such a lighting module comprising an LED 121 is shown in [FIG. 1] by no means restrictively, and comprises a support 120 with electrically conductive tracks, such as a printed circuit card, for example a rectangular support, on which LED 121 is mounted.

In the embodiment shown in [FIG. 1], the light source is arranged opposite the first main face 112_1 of the inner sheet 112. More particularly, LED 121 is in contact with said first main face 112_1. In this configuration, at least some of the light generated by the light source is incident on said first main face 112_1 so as to pass through the inner sheet 112 and leave it at its second main face 112_2. In addition, the light injection means also comprise a light redirection element 130 arranged at said second main face 112_2 and configured so that light leaving said second main face 112_2 and coming into contact with said redirection element 130 is reflected into the inner sheet 112.

According to a more particular exemplary embodiment, said light redirection element 130 is a reflective structure provided with a plurality of reflective surfaces in the form of inclined surfaces (that is, the inclined surfaces are coated with a reflective layer). The said reflective surfaces are configured so that light leaving the second main face 112_2 and coming into contact with them is reflected into the inner sheet 112. Such a reflective structure is described, for example, in document WO2022096365 as a prismatic film.

It should be noted that there is nothing to preclude the consideration of other embodiments wherein the LED 121, and therefore ultimately the light source, is at a distance from the first main face 112_1 of the inner sheet 112.

In addition, LED-based illumination is just one variant of the invention. This does not rule out the use of other types of light source, such as one or more organic light-emitting diodes (OLEDs), one or more laser diodes, electroluminescent material, and so on. Generally speaking, there is no limitation on the nature of the light source, as long as it is suitable for injecting light into a glass sheet.

As mentioned above, the light injected into the inner sheet 112 is intended to propagate by reflection between said first and second main faces 112_1, 112_2. This light propagation is carried out until it reaches light extraction means which, in the present embodiment, are configured to extract and diffuse the light injected into the inner sheet 112 towards the interior of the car.

More particularly, and as shown in [FIG. 1] by no means restrictively, said extraction means are preferably a diffusing coating 140, for example opaque white or transparent, located at the second main face 112_2 of the inner sheet 112.

The scattering coating 140 may, for example, comprise a matrix (organic or mineral) and scattering particles, for example of metal oxide (TiO2, etc.).

Such a diffusing coating 140 made of mineral material is, for example, described in document FR3084355 as a transparent enamel. Alternatively, such a scattering coating 140 made of mineral material is, for example, described in document WO2022023638 as a transparent layer.

It should be noted that for reasons of simplification of the description and [FIG. 1], a single diffusing coating 140 is considered here. However, there is no limit to the number of diffusing coatings that can be used to extract light. This absence of limitation also applies to the nature of these diffusing coatings, as well as their respective positions with respect to the glass sheets 111, 112, depending on whether it is desired to extract light towards the interior and/or exterior of the car. Generally speaking, these aspects are well known to those skilled in the art and are therefore not described further here.

The glazed assembly 100 further comprises:
an opaque material 150 (that is, opposing the passage of light) in continuous and direct contact with a main face of glazing 110 and positioned between the light injection means and the light extraction means,
means for retaining the opaque material against the glazing 110 by compression.

By “continuous contact”, we mean uniform contact, with no disparity (that is, no gap) between the glazing 110 and the opaque material 150. Such continuous contact, coupled with compression retention in the present embodiment, advantageously prevents any leakage of stray light (grazing light) from the light source.

Furthermore, by “direct contact”, we are referring to the fact that the contact in question between the glazing 110 and the opaque material 150 is achieved without adhesive means, in particular without translucent adhesive means. Such arrangements are particularly advantageous in that they prevent any local absorption of light at the point of contact between the glazing 110 and the opaque material 150, and therefore a fortiori prevent the appearance of a halo effect.

More particularly, in the embodiment shown in [FIG. 1], the opaque material 150 is in continuous and direct contact with the first main face 112_1 of the inner sheet 112, the retention means being configured to retain said opaque material 150 by compression against said first main face 112_1.

It should be noted that if glazing 110 has a functional layer on face F4, as previously mentioned with reference to certain embodiments of the invention, opaque material 150 is then arranged in continuous and direct contact with said functional layer.

The opaque material 150 is, for example, an elastic material, such as an elastomer, thermoplastic elastomer or foam. However, other examples not detailed here do not preclude the opaque material 150 from being inelastic, as long as it can be arranged in continuous, direct contact with the first main face 112_1 of the inner sheet 112. For example, a non-compressible opaque material can be used, the shape of which is adapted to any curvature of the glazing 110 prior to assembly of the glazed assembly 100.

The opaque material 150 is not arranged opposite the light extraction means in a direction substantially perpendicular to the glazing. A light extraction zone is defined comprising all the light extraction means and a projection of the light extraction zone in a projection plane perpendicular to the glazing. A projection of the opaque element 250 in said projection plane is outside the projection of the light extraction zone.

In the embodiment shown in [FIG. 1], the retaining means comprise a support element 160, for example a plate, with a first side facing the first side 112_1 of the inner sheet 112. It should be noted that such a support element is also known as a “bracket” in Anglo-Saxon literature. The light source (more specifically, the PCB support 120 here) is attached to this first face of the support element 160, this attachment being achieved by any known means, for example by bonding. The support element also has a second, opposite face. The opaque material 150 is also attached to the first face of the support element 160. Here again, this attachment can be achieved by any known means, for example using a suitable adhesive 151 as shown in [FIG. 1].

In addition to the support element 160, in the present embodiment the

retaining means also comprise a retaining element 170 comprising a first and a second “retaining” arm 171, 172 connected together by a “connecting” arm 173. According to this configuration, and as shown in FIG. 1, the retaining element has a substantially “Z”-shaped profile in cross-section. The first retaining arm 171 is attached against the first main face 112_1 of the inner sheet 112, on the side opposite the opaque material 150 with respect to the light source. The second retaining arm 172 is attached against a second face of the support element 160.

Attaching the first retaining arm 171 to the first main face 112_1 of the inner sheet 112 (respectively attaching the second retaining arm 172 to the second face of the support element 160) can be achieved by any known means, for example using a suitable adhesive 174 (respectively a suitable adhesive 175) as shown in [FIG. 1], or by encapsulating the retaining arm 171 on the glass.

The retaining means described with reference to [Fig. 1] represent only one variant of the invention. Other variants are also possible, such as one wherein the light source and the opaque material 150 are attached to the second retaining arm 172 of the retaining element 170. In other words, in this alternative variant, the support element 160 of [FIG. 1] is absent and replaced by said second retaining arm 172, whose length is adapted accordingly.

In addition, the invention has so far been described on the basis that the light source is arranged opposite the first main face 112_1 of the inner sheet 112. Such arrangements are not limiting of the invention, as other light source arrangements can be envisaged.

Thus, in particular embodiments of the invention, the light source can be arranged at least partially in a through hole of a glass sheet, for example in a through hole of the inner sheet when the glazing is laminated, said light source being:
in contact with a wall of the hole positioned between the light source and the light extraction means, or
at a distance from the walls of the hole.

[FIG.2] schematically depicts another particular embodiment of a glazed

assembly 200 according to the invention.

In the embodiment shown in [FIG. 2], and as described with reference to [FIG. 1], the glazing is laminated and corresponds to a glazed roof. [FIG. 2] shows a cross-sectional view of the glazed roof. For the sake of simplicity, only the inner sheet 212 is shown.

As shown in [FIG. 2], an LED module light source 220 is partially arranged in a through hole 230 in the inner sheet 212. More particularly, the LED module comprises:
an LED 221 arranged to inject light into the inner sheet 212 via the wall of hole 230,
a light guide 222 for the light generated by the LED 221,
a protective cover 223.

The LED module 220 is retained against the first main face 212_1 of

the inner sheet 212 by fixed or reversible cooperation, of a type known per se (for example, clip-on), with a support plate 240 (also called bracket).

As shown in [FIG. 2], the support plate 240 has side walls 241, 242 rising substantially orthogonally to the inner glass sheet 212. The support plate 240 also has a strip 243 projecting in the direction wherein light is intended to propagate through the inner sheet 212 (that is, towards the light extraction means (not shown in [FIG. 2]). The strip 243, for example, is produced so as to be integral with the side wall 241, or can be designed as an add-on part attached to said side wall 241.

Furthermore, said strip 243 is arranged at a distance from the first main face 212_1 of the inner sheet 212, so as to present a gap with the glazing. This gap is filled by an opaque material 250 with the same characteristics as those described above. In particular, said opaque material 250 is attached to said strip 243, for example by adhesive means of a type known per se. On the other hand, contact between the opaque material 250 and the glazing is continuous and direct.

It is therefore understood that in this embodiment of [Fig.2], the means for retaining the opaque material 250 against the first main face 212_1 by compression comprise said support plate 240, in particular via said strip 243.

The positioning of the LED module 220, and more particularly the LED diode 221, enables the inner sheet 212 to be illuminated via the wall of the hole 230. As shown in [FIG. 2], some of the generated light is injected into the inner sheet 212 (arrow FL1). However, another part of the generated light tends to escape between the support plate 240 and the first main face 212_1 (arrow FL2), and as such represents a stray grazing light intended to be blocked by the opaque material 250 placed in opposition.

For more details on the general principles of injecting light into a glass

sheet via a hole in the sheet, see, for example, WO2018178591.

Furthermore, it should be considered that the LED module 220 being retained against the first main face 212_1 of the inner sheet 212 by cooperation with a support plate 240 is only one variant implementation of the invention. Other variants are also possible, such as an LED module 220 attached directly to the first main face 212_1 of the inner sheet 212, whereby the strip 243 can be made to match the cover 223, or as an attachment attached to the cover 223.

[FIG. 3] is a schematic three-quarter view of the retaining means 240 of the glazed assembly 200 of FIG. 2, to which said opaque material 250 is attached.

[FIG. 4] shows schematically yet another particular embodiment of a glazed assembly according to the invention. More particularly, the embodiment of [FIG. 4] is shown here as an alternative embodiment to the embodiment of FIGS. 2 and 3, with no compression retaining means being used here.

To this end, the opaque material 250 is produced, for example, by depositing or injecting (that is, reaction injection molding) a PU (polyurethane) type adhesive directly onto the first main face 212_1 of the inner sheet 212, or by PU or TPE (thermoplastic elastomer) encapsulation, or by injection of a thermoplastic.

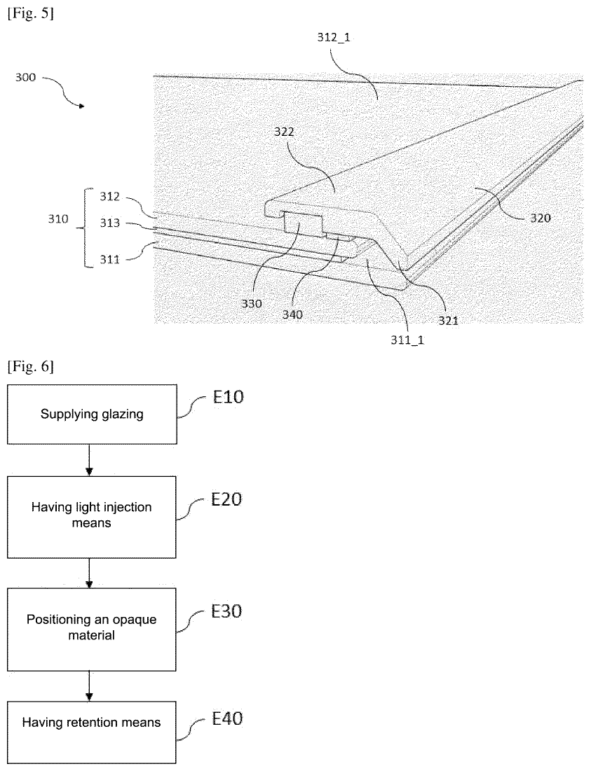

It should be noted that the absence of compression retaining means can ultimately be applied to all the modes envisaged in the present description, in any technically operable combination, via the aforementioned deposition/injection/encapsulation methods.

[FIG. 5] shows schematically yet another particular embodiment of a glazed assembly 300 according to the invention.

In the embodiment of [FIG. 5], and in the manner described with reference to FIGS. 1, 2, 3 and 4, the glazing is laminated and corresponds to a glazed roof 310 comprising an inner sheet 312, an outer sheet 311, and an interlayer film 311. [FIG. 5] shows a three-quarter view of the glass assembly 300.

Unlike the modes described with reference to FIGS. 1, 2, 3 and 4, light is injected through the edge of the glazing (the light injection means are not shown in [FIG. 5]).

In addition, and as shown in [FIG. 5], the glazed assembly 300 comprises a retaining element 320 comprising a first and a second retaining arm 321, 322, connected together, so that said retaining element 320 has, in cross-section, a substantially “V”-shaped profile.

The first retaining arm 321 is fixedly arranged in abutment against the first main face 311_1 of the outer sheet 311, the latter having a periphery extending substantially beyond that of the inner sheet 312.

The second retaining arm 322, meanwhile, extends substantially parallel to and at a distance from the first main face 312_2 of the inner sheet 312, so as to present a gap with the glazing. This gap is filled by an opaque material 330 having the same characteristics as those described above. In particular, said opaque material 330 is attached to said second retaining arm 322 (for example, by fitting into a groove in the second retaining arm 322, as shown in [FIG. 5]), for example by adhesive means of a type known per se. On the other hand, contact between the opaque material 330 and the glazing is continuous and direct.

To ensure optimum support of the retaining element 320 against the glazing, adhesive means 340 can be used between the second retaining arm 322 and the first main face 312_1 of the inner sheet 312, as shown non-limitingly in [FIG. 5]. These adhesive means 340 are placed between the light source and the opaque material 330 so that if they generate a halo effect, this is concealed by the opaque material 350.

It is therefore understood that in this embodiment of [FIG. 4], the means for retaining the opaque material 330 by compression against the first main face 312_1 comprise said retaining element 320, in particular via said second arm 322.

For more details on the general principles of injecting light into a glass sheet via its edge, as is the case in the embodiment shown in [FIG. 5], see, for example, document WO2010049638.

So far, the invention has been described on the basis that light is injected into the inner sheet of laminated glazing. However, the invention also applies in the case where this light injection is carried out in the outer sheet of laminated glazing.

It has also been assumed until now that the glazing into which light is injected is laminated glazing. Such arrangements are not, however, limiting of the invention, and nothing precludes considering the case of a monolithic glazing, for example a monolithic glazing whose face F1 is the face with which the opaque material is in continuous and direct contact.

According to still other considerations, and irrespective of whether the glazing is monolithic or laminated, or whether the light injection is produced in an inner or outer sheet, the invention also covers embodiments wherein the light injection is produced by means of an optical system configured to carry out an optical function from the light generated by the light source. There is no limitation on the nature of said optical system, which may for example correspond to a collimating optical system. The use of such an optical system therefore refers here to the injection of light by indirect coupling between the light source and the glazing. Conversely, the optical coupling in question can be direct, as described above in the embodiments of FIGS. 1 to 5, that is, no optical system is used.

In yet other respects, the glazed assembly has so far been described as being integrated into the motor vehicle, that is, as being functionally operative within said vehicle. However, the invention also covers the case of a glazed assembly supplied in kit form. To this end, the glazing, light injection means, opaque material and retaining means can be pre-assembled together, in whole or in part, in any technically feasible combination. All components can possibly be supplied separately in the kit. Such a kit can also be supplied with assembly instructions for the various components.

Another aspect of the invention is a method for manufacturing a glazed assembly as described above. [FIG. 6] shows a flowchart of the main steps involved in such a manufacturing method, which consist of:
providing E10 a glazing for a motor vehicle comprising a glass sheet having a first main face and a second opposite main face,
having E20 means for injecting light into the glass sheet, said injection means comprising a light source, at least part of the light generated by the light source being injected into the glass sheet to propagate by reflection between said first and second main faces until it reaches light extraction means,
positioning E30, between the light injection means and the light extraction means, an opaque material in continuous and direct contact with the first main face,
having E40 means for retaining the opaque material against the first main face by compression.

It should be noted that step E40 is optional for the purposes of the invention, since as already mentioned, the latter also covers embodiments wherein compression retaining means are not used (see [FIG. 4] as an example).

1. A glazed assembly comprising:
a glazing for a motor vehicle comprising a sheet of organic or inorganic glass having a first main face and a second opposite main face,
light injection means in the glass sheet, said injection means comprising a light source, at least part of the light generated by the light source being injected into the glass sheet to propagate by reflection between said first and second main faces until reaching light extraction means, and
an opaque material in continuous and direct contact with the first main face and positioned between the light injection means and the light extraction means.

2. The glazed assembly as claimed in claim 1, wherein the glazed assembly also comprises means for retaining the opaque material against the first main face by compression.

3. The assembly according to claim 2, wherein said retaining means comprises:
a support element comprising a first face to which the light source is attached, and a second opposite face, the opaque material being attached to the first face of the support element,
a retaining element comprising a first and a second retaining arm connected together by a connecting arm, the first retaining arm being attached in abutment against the first main face of the glass sheet on the side opposite the opaque material with respect to the light source, the second retaining arm being attached in abutment against the second face of the support element.

4. The glazed assembly according to claim 2, wherein the retention means comprise a retaining element having first and second retaining arms connected together by a connecting arm, the first retention arm being attached in abutment against the first main face of the glass sheet on the side opposite the opaque material with respect to the light source, the light source and the opaque material being attached to the second retaining arm.

5. The glazed assembly according to claim 1, wherein the light source is arranged opposite the first main face, in contact with or at a distance from the first main face, at least part of the light generated by the light source being incident on the first main face so as to pass through the glass sheet to leave it at the second main face, the light injection means further comprising a light redirection element arranged at the second main face and configured so that light leaving the second main face and coming into contact with said redirection element is reflected in the glass sheet.

6. The glazed assembly according to claim 5, wherein the light redirection element is a reflective structure provided with a plurality of reflective surfaces in the form of inclined surfaces, the reflective surfaces being configured so that light leaving the second main face and coming into contact therewith is reflected into the glass sheet.

7. The glazed assembly according to claim 1, wherein the light source is arranged at least partially in a through hole of the glass sheet, said light source being:
in contact with a wall of the hole positioned between the light source and the light extraction means, or
at a distance from the walls of the hole.

8. The glazed assembly according to claim 1, wherein the glazing is a monolithic glazing, said first main face being face F1.

9. The glazed assembly according to claim 1, wherein the glazing is a laminated glazing comprising two sheets of glass, an outer sheet and an inner sheet, separated by an interlayer film, said first main face being face F4.

10. The glazed assembly according to claim 9, wherein the through hole is made in the inner sheet.

11. The glazed assembly according to claim 9, wherein the glazing comprises a functional layer.

12. The glazed assembly according to claim 9, wherein the outer sheet is tinted and/or the interlayer film is tinted at least in sections.

13. The glazed assembly according to claim 1, wherein the light source comprises one or more illuminating modules, each illuminating module comprising one or more light-emitting diodes.

14. The glazed assembly according to claim 1, wherein:
light injection is achieved by direct optical coupling between the light source and the glazing, or
light injection is achieved by means of an optical system configured to perform an optical function from the light generated by the light source.

15. The glazed assembly according to claim 1, wherein the opaque material is an elastic material.

16. A method of manufacturing a glazed assembly, comprising:
providing a glazing for a motor vehicle comprising an organic or mineral glass sheet having a first main face and a second opposite main face,
arranging light injection means in the glass sheet, said injection means comprising a light source, at least part of the light generated by the light source being injected into the glass sheet to propagate by reflection between said first and second main faces until reaching light extraction means, and
positioning, between the light injection means and the light extraction means, an opaque material in continuous and direct contact with the first main face.

17. The method according to claim 16, said method further comprising consisting in arranging retention means by compressing the opaque material against the first main face.

18. A method comprising providing a glazed assembly according to claim 1 in a motor vehicle.

19. A motor vehicle comprising a glazed assembly according to claim 1.

20. The assembly according to claim 3, wherein the support element is a plate.
